(19) United States
(12) Patent Application Publication
(10) Pub. No.: US 2021/0303788 A1
(43) Pub. Date: Sep. 30, 2021

(54) HOST APPARATUS, IMAGE FORMING APPARATUS, AND NON-TRANSITORY COMPUTER READABLE RECORDING MEDIUM THAT STORES PSEUDO-COMBINED-CHARACTER RENDERING PROGRAM

(71) Applicant: KYOCERA DOCUMENT SOLUTIONS INC., Osaka (JP)

(72) Inventor: KEIZEN KANAZAWA, CONCORD, CA (US)

(21) Appl. No.: 16/833,807

(22) Filed: Mar. 30, 2020

(51) Int. Cl. G06F 40/274; G06F 40/232; G06F 3/01; G06F 3/12

(52) U.S. Cl. CPC G06F 40/274; G06F 3/126; G06F 3/018; G06F 40/232

(57) ABSTRACT

A host apparatus includes a character input module in which multiple characters are input, a word conversion module configured to convert the multiple characters into a word, a first pseudo-combined-character determining module configured to determine whether a pseudo-combined-character of the word is creatable, where the pseudo-combined-character is creatable, determine whether or not the pseudo-combined-character of the word is to be rendered, and where the pseudo-combined-character is to be rendered, add a special code onto a certain position of multiple character codes, the multiple character codes standing for the multiple characters included in the word, the special code indicating that the multiple characters are to be rendered in the pseudo-combined-character, and a first pseudo-combined-character rendering module configured to render the multiple characters in the pseudo-combined-character and display the pseudo-combined-character on the display device, the multiple characters being specified by the multiple character codes onto which the special code is added.

### FIELD OF THE DISCLOSURE

The present disclosure relates to a host apparatus configured to execute word processor software. The present disclosure relates to an image forming apparatus configured to print printable data received from the host apparatus. The present disclosure relates to a non-transitory computer readable recording medium that stores a pseudo-combined-character rendering program executable by the host apparatus.

### BACKGROUND OF THE DISCLOSURE

There is known word processor software configured to render a combined-character including multiple characters in a single character area.

### SUMMARY OF THE DISCLOSURE

According to an embodiment of the present disclosure, there is provided a host apparatus, including:

a display device; and

a controller circuit configured to operate as

a character input module in which multiple characters are input,

a word conversion module configured to convert the multiple characters into

a word,

a first pseudo-combined-character determining module configured to
determine whether or not a pseudo-combined-character of the word is creatable,
where the pseudo-combined-character is creatable, determine whether or not the pseudo-combined-character of the word is to be rendered, and
where the pseudo-combined-character is to be rendered, add a special code onto a certain position of multiple character codes, the multiple character codes standing for the multiple characters included in the word, the special code indicating that the multiple characters are to be rendered in the pseudo-combined-character, and

a first pseudo-combined-character rendering module configured to render the multiple characters in the pseudo-combined-character and display the pseudo-combined-character on the display device, the multiple characters being specified by the multiple character codes onto which the special code is added.

According to an embodiment of the present disclosure, there is provided an image forming apparatus, including:

a communication device;

a printer device; and

a controller circuit configured to operate as

a second pseudo-combined-character determining module configured to detect multiple character codes and a special code from printable data received from a host apparatus via the communication device, the multiple character codes standing for multiple characters, the special code being added onto a certain position of the multiple character codes, the special code indicating that the multiple characters are to be rendered in a pseudo-combined-character, and

a second pseudo-combined-character rendering module configured to render the multiple characters in the pseudo-combined-character such that the printer device prints the pseudo-combined-character, the multiple characters being specified by the multiple character codes onto which the special code is added.

According to an embodiment of the present disclosure, there is provided a non-transitory computer readable recording medium that stores a pseudo-combined-character rendering program executable by a host apparatus including a display device and a controller circuit, the pseudo-combined-character rendering program causing the controller circuit of the host apparatus to operate as

a character input module in which multiple characters are input,

a word conversion module configured to convert the multiple characters into a word,

a first pseudo-combined-character determining module configured to
determine whether or not a pseudo-combined-character of the word is creatable,
where the pseudo-combined-character is creatable, determine whether or not the pseudo-combined-character of the word is to be rendered, and
where the pseudo-combined-character is to be rendered, add a special code onto a certain position of multiple character codes, the multiple character codes standing for the multiple characters included in the word, the special code indicating that the multiple characters are to be rendered in the pseudo-combined-character, and

a first pseudo-combined-character rendering module configured to render the multiple characters in the pseudo-combined-character and display the pseudo-combined-character on the display device, the multiple characters being specified by the multiple character codes onto which the special code is added.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows a pseudo-combined-character rendering system according to an embodiment of the present disclosure;

FIG. 2 shows a hardware configuration of an image forming apparatus;

FIG. 3 shows a hardware configuration of a host apparatus;

FIG. 4 shows a functional configuration of the host apparatus;

FIG. 5 shows a functional configuration of the image forming apparatus;

FIG. 6 shows an operational flow of the host apparatus;

FIG. 7 shows a specific example of one pseudo-combined-character and multiple normal characters displayed on the display device as options;

FIG. 8 shows a specific example of two characters rendered in a pseudo-combined-character;

FIG. 9 shows a specific example of four characters rendered in a pseudo-combined-character; and

FIG. 10 shows an operational flow of the image forming apparatus.

### DETAILED DESCRIPTION OF THE EXEMPLARY EMBODIMENTS

Hereinafter, an embodiment of the present disclosure will be described with reference to the drawings.

1. Pseudo-Combined-Character Rendering System

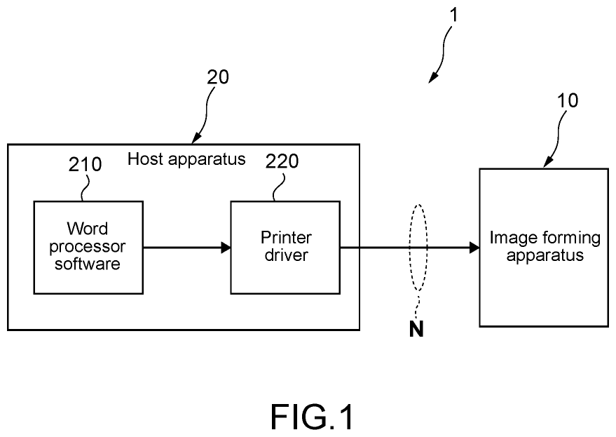

FIG. 1 shows a pseudo-combined-character rendering system according to an embodiment of the present disclosure.

The pseudo-combined-character rendering system 1 includes the image forming apparatus 10 and the host apparatus 20. The image forming apparatus 10 and the host apparatus 20 are communicably connected to each other via the network N such as the Internet or a LAN. Alternatively, the image forming apparatus 10 and the host apparatus 20 may be communicably connected to each other not via the network N (i.e., via near field communication, etc.) (not shown).

The host apparatus 20 is a terminal device for end users such as a personal computer, a tablet computer, or a smartphone, for example. The host apparatus 20 creates a document by using the word processor software 210, creates printable data of the document by using the printer driver 220, and sends the printable data to the image forming apparatus 10.

The image forming apparatus 10 is, for example, an MFP (Multifunction Peripheral). The image forming apparatus 10 receives the printable data from the host apparatus 20, and prints the document.

A set of character codes such as JIS or Unicode has character codes for rendering combined-characters. The “combined-character” is a character including multiple characters in a single character area, and is used to have more information in a limited space. According to the “character code for rendering a combined-character”, one character stands for a “combined-character” i.e., a “character including multiple characters in a single character area”. For example, in Unicode for Japanese language, one character code “Unicode U+330D JIS 13-42” stands for a “character including multiple characters “calorie” (in Japanese language) in a single character area”. In the combined-character “calorie” in Japanese language, the multiple characters “calorie” (in Japanese language) are arranged, in a single character area, from the upper tier to the lower tier sequentially and readably. As described above, a set of character codes includes character codes standing for such combined-characters. However, combined-characters included in a set of character codes are not all the words including multiple characters. As a result, where a set of character codes does not include a character code standing for a combined-character of a certain word, it is impossible to render a combined-character of such a word.

In view of the aforementioned circumstances, the present embodiment provides the pseudo-combined-character rendering system 1 including the host apparatus 20 and the image forming apparatus 10. The host apparatus 20 is configured to create a combined-character (hereinafter, referred to as “pseudo-combined-character”) of a word, where a character code standing for a combined-character of the word is not included in a set of character codes. The image forming apparatus 10 is configured to print the pseudo-combined-character. The present embodiment discloses, as an example, the word processor software 210 for Japanese language. However, the pseudo-combined-character rendering system 1 is not particularly limited to Japanese language, but applicable to any languages.

2. Hardware Configuration of Image Forming Apparatus

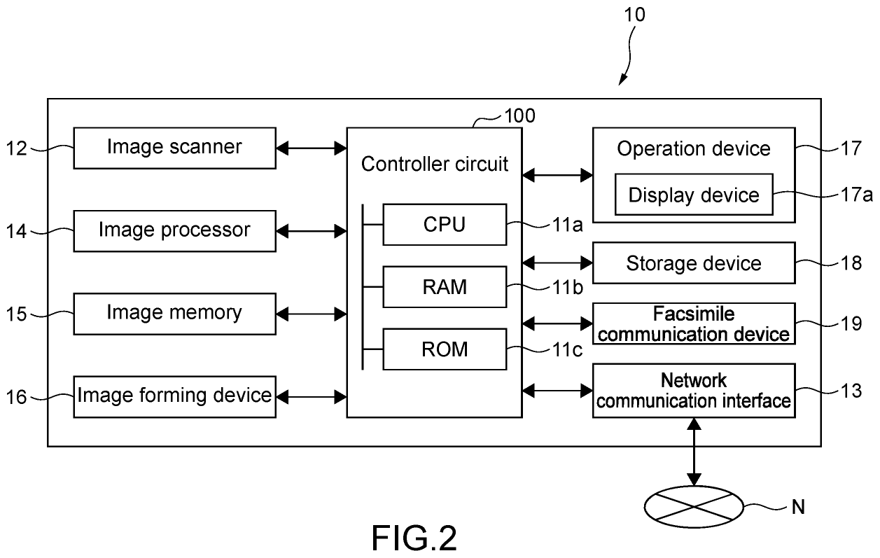

FIG. 2 shows a hardware configuration of an image forming apparatus.

The image forming apparatus 10 includes the controller circuit 100. The controller circuit 100 includes the CPU (Central Processing Unit) 11a, the RAM (Random Access Memory) 11b, the ROM (Read Only Memory) 11c, dedicated hardware circuits, and the like and performs overall operational control of the image forming apparatus 10. The CPU 11a loads information processing programs stored in the ROM 11c in the RAM 11b and executes the information processing programs. The ROM 11c is a nonvolatile memory that stores programs executable by the CPU 11a, data, and the like. The ROM 11c is an example of a non-transitory computer readable recording medium.

The controller circuit 100 is connected to the image scanner 12, the image processor 14 (including GPU (Graphics Processing Unit)), the image memory 15, the image forming device 16 (printer device), the operation device 17 including the display device 17a (touch panel), the large volume nonvolatile storage device 18 such as an HDD (Hard Disk Drive) or an SSD (Solid State Drive), the facsimile communication device 19, the network communication interface 13, and the like. The controller circuit 100 performs operational control of the respective devices connected thereto and sends/receives signals and data to/from those devices. The operation device 17 (touch panel) is one mode of an input device. A sound input device including a microphone may be provided as an input device.

3. Hardware Configuration of Host Apparatus

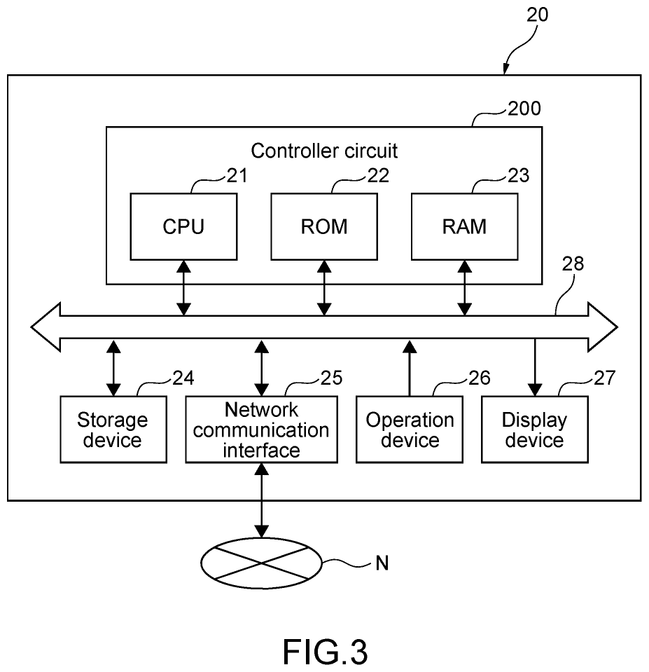

FIG. 3 shows a hardware configuration of a host apparatus.

The host apparatus 20 includes the CPU 21, the ROM 22, the RAM 23, the storage device 24, which is a large-volume nonvolatile memory such as an HDD or an SSD, the network communication interface 25, the operation device 26, and the display device 27, and the bus 28 connecting them to each other. The operation device 26 is one mode of an input device. A sound input device including a microphone may be provided as an input device.

The controller circuit 200 includes the CPU 21, the ROM 22, and the RAM 23. The CPU 21 loads information processing programs stored in the ROM 22 in the RAM 23 and executes the information processing programs. The ROM 22 stores programs executable by the CPU 21, data, and the like nonvolatile. The ROM 22 is an example of a non-transitory computer readable recording medium.

4. Functional Configuration of Host Apparatus

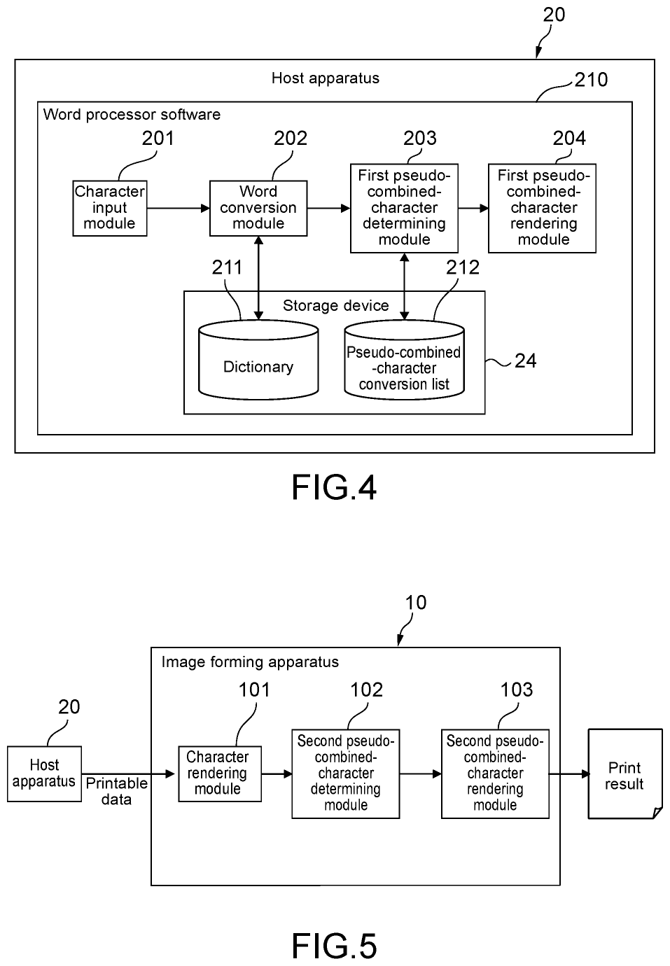

FIG. 4 shows a functional configuration of the host apparatus.

In the controller circuit 200 of the host apparatus 20, the CPU 21 loads a pseudo-combined-character rendering program of the word processor software 210 stored in the ROM 22 in the RAM 23 and executes the pseudo-combined-character rendering program to operate as the character input module 201, the word conversion module 202, the first pseudo-combined-character determining module 203, and the first pseudo-combined-character rendering module 204. The storage device 24 of the host apparatus 20 stores the dictionary 211 and the pseudo-combined-character conversion list 212.

The dictionary 211 includes a list of words. A word includes one character or multiple characters. Japanese language has homophones. Homophones of Japanese language mean different combinations of multiple characters (typically, Chinese characters, i.e., kanji) for the same spelling (of plain Japanese characters, i.e., hiragana) and the same pronunciation. The dictionary 211 registers different multiple words including different multiple characters (typically, Chinese characters, i.e., kanji) for one spelling (of plain Japanese characters, i.e., hiragana).

The pseudo-combined-character conversion list 212 registers multiple words, which are renderable as pseudo-combined-characters. Each of all the words registered in the pseudo-combined-character conversion list 212 includes multiple characters (including hiragana (plain Japanese characters), katakana (simpler Japanese characters), kanji (Chinese characters used in Japanese language), numbers, and/or alphabets, etc.). For example, the pseudo-combined-character conversion list 212 may register, as multiple words including multiple Chinese characters (i.e., kanji), multiple words having high use frequencies, multiple words having antonyms, and/or multiple words having synonyms.

5. Functional Configuration of Image Forming Apparatus

FIG. 5 shows a functional configuration of the image forming apparatus.

In the controller circuit 100 of the image forming apparatus 10, the CPU 11a loads an information processing program stored in the ROM 11c in the RAM 11b and executes the information processing program to operate as the character rendering module 101, the second pseudo-combined-character determining module 102, and the second pseudo-combined-character rendering module 103.

6. Operational Flow of Host Apparatus

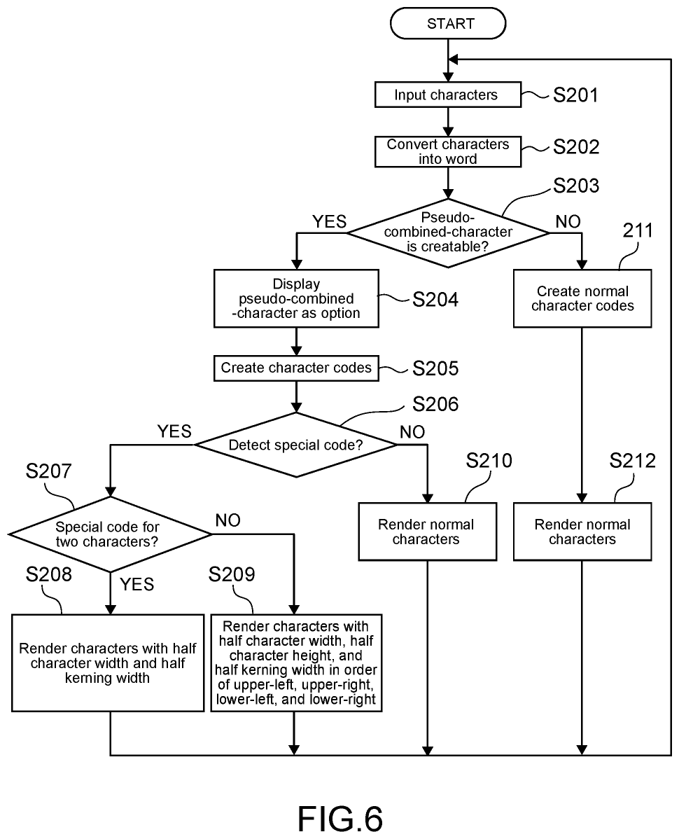

FIG. 6 shows an operational flow of the host apparatus.

The character input module 201 determines characters/a character input via the operation device 26 by a user (Step S201).

With reference to the dictionary 211, the word conversion module 202 converts the input characters/character into a word (Step S202). Where the input characters/character are/is to be converted into multiple words (for example, homophones of Japanese language), the word conversion module 202 converts the input characters/character into multiple words being options.

The first pseudo-combined-character determining module 203 determines whether or not a pseudo-combined-character of each word converted by the word conversion module is creatable (Step S203). For example, where a word is stored in the pseudo-combined-character conversion list 212, the first pseudo-combined-character determining module 203 determines that a pseudo-combined-character of the word is creatable. Alternatively, the first pseudo-combined-character determining module 203 may determine that pseudo-combined-characters of all the words including multiple characters (typically, two characters, three characters, and/or four characters) are creatable. In this case, the host apparatus 20 does not need to have the pseudo-combined-character conversion list 212.

The first pseudo-combined-character determining module 203 determines that pseudo-combined-characters/character of the words/word converted by the word conversion module 202 are/is creatable (Step S203, YES). Then, the first pseudo-combined-character determining module 203 displays, as options, pseudo-combined-characters/character of each of the words/word and multiple normal characters (not pseudo-combined-characters/character) of each of the words/word on the display device 27 (Step S204). In other words, the first pseudo-combined-character determining module 203 displays, for one word whose pseudo-combined-character is creatable, two options (i.e., pseudo-combined-character, and multiple normal characters which is not a pseudo-combined-character).

However, where a large number of options are displayed, a user may feel uncomfortable. So the first pseudo-combined-character determining module 203 may limit the total number (i.e., fixed value) of multiple pseudo-combined-characters and multiple normal characters displayed on the display device 27. Further, the first pseudo-combined-character determining module 203 may display multiple pseudo-combined-characters of a certain number of multiple words, respectively, and may not display multiple pseudo-combined-characters of the rest multiple words, respectively. For example, the first pseudo-combined-character determining module 203 may display multiple pseudo-combined-characters of multiple words of the top 20% of the options, and may not display multiple pseudo-combined-characters of the rest (i.e., 80%) multiple words.

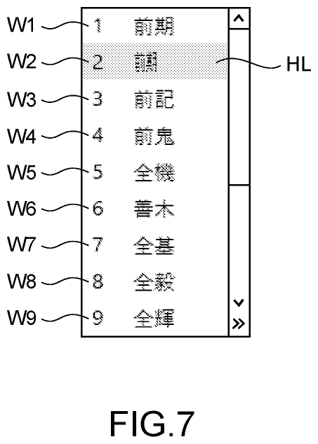

FIG. 7 shows a specific example of one pseudo-combined-character and multiple normal characters displayed on the display device as options.

The first pseudo-combined-character determining module 203 displays the nine options W1 to W9. The nine options W1 to W9 are different multiple words (i.e., homophones) converted from the common multiple characters “zenki” (in hiragana, i.e., plain Japanese characters) of Japanese language. The options W1 and W2 stand for the same word “zen-ki” (in kanji, i.e., Chinese characters) (one word whose pseudo-combined-character is creatable). The option W1 displays the word “zen-ki” (in kanji, i.e., Chinese characters) in two normal characters, not a pseudo-combined-character. Meanwhile, the option W2 displays the same word “zen-ki” (in kanji, i.e., Chinese characters) in a pseudo-combined-character. The rest options W3 to W9 display different words (i.e., homophones) in two normal characters, not pseudo-combined-characters.

A user refers to pseudo-combined-characters/character and multiple normal characters (one or multiple), not pseudo-combined-characters/character, displayed on the display device 27 as options. The user selects one option (pseudo-combined-character or multiple normal characters) via the operation device 26 (input device). The first pseudo-combined-character determining module 203 detects the one option (pseudo-combined-character or multiple normal characters) selected via the operation device 26.

Where one pseudo-combined-character is selected via the operation device 26, the first pseudo-combined-character determining module 203 determines that the selected pseudo-combined-character is to be rendered. In this case, the first pseudo-combined-character determining module 203 adds a special code onto a certain position of (for example, immediately before) the multiple character codes standing for the multiple characters included in the selected word. The first pseudo-combined-character determining module 203 supplies the created character codes to the first pseudo-combined-character rendering module 204 (Step S205).

The “special code” is a code indicating that multiple characters are to be rendered in a pseudo-combined-character, and is assigned to a private use area of a set of character codes. The “special code” is different depending on a number of multiple characters to be rendered in a pseudo-combined-character. In other words, a special code indicating that two characters are to be rendered in a pseudo-combined-character is different from a special code indicating that four characters are to be rendered in a pseudo-combined-character. For example, in Unicode, “U+E000” may be a special code indicating that two characters are to be rendered in a pseudo-combined-character, and “U+E002” may be a special code indicating that four characters are to be rendered in a pseudo-combined-character.

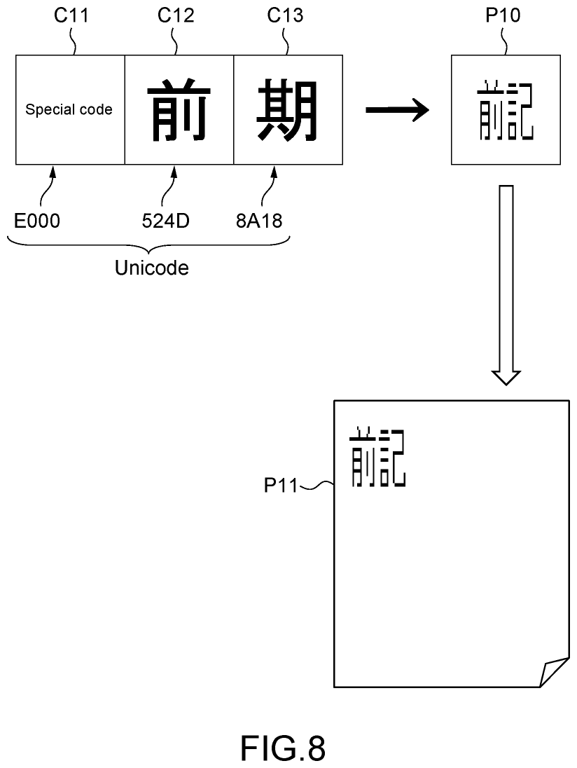

FIG. 8 shows a specific example of two characters rendered in a pseudo-combined-character.

In FIG. 7, the option W2 (pseudo-combined-character of the word “zen-ki” in kanji, i.e., Chinese characters) is selected (FIG. 7, highlight HL). In Unicode, the character code “524D” stands for the character “zen” C12 of Japanese language, and the character code “8A18” stands for the character “ki” C13 of Japanese language. “E000” is the special code C11 indicating that two characters are to be rendered in a pseudo-combined-character. Therefore, where the character “zen” C12 and the character “ki” C13 of Japanese language are rendered in a pseudo-combined-character, the character codes are “E000 524D 8A18”. The character codes “E000 524D 8A18” stand for the “special code indicating that two characters are to be rendered in a pseudo-combined-character” C11, the character “zen” C12, and the character “ki” C13. Note that the character codes “E000 524D 8A18” are exchangeable for “0xE0 0x00 0x52 0x4D 0x8A 0x18”.

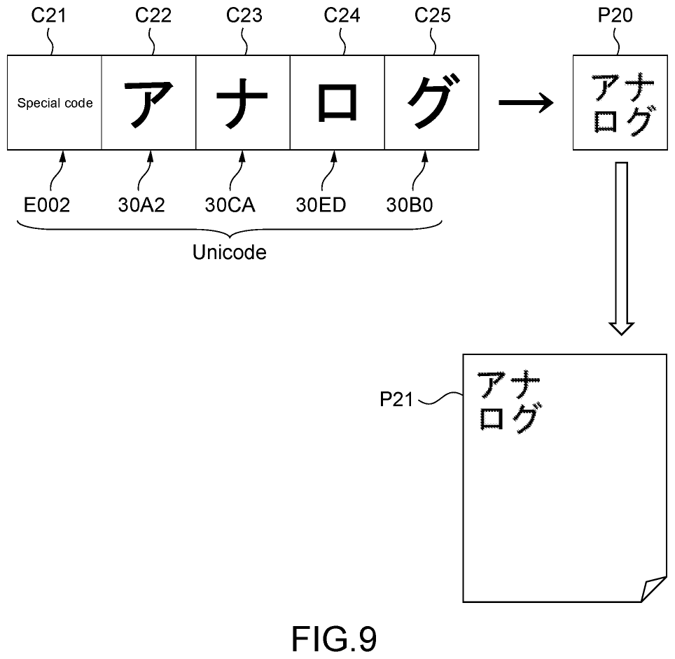

FIG. 9 shows a specific example of four characters rendered in a pseudo-combined-character.

The word “a-na-ro-gu” (in katakana, i.e., simpler Japanese characters) of Japanese language is rendered in a pseudo-combined-character. In Unicode, the character code “30A2” stands for the character “a” C22 of Japanese language, the character code “30CA” stands for the character “na” C23 of Japanese language, the character code “30ED” stands for the character “ro” C24 of Japanese language, and the character code “30B0” stands for the character “gu” C25 of Japanese language. “E002” is the special code C21 indicating that four characters are to be rendered in a pseudo-combined-character. Therefore, where the character “a” C22, the character “na” C23, the character “ro” C24, and the character “gu” C25 of Japanese language are rendered in a pseudo-combined-character, the character codes are “E002 30A2 30CA 30ED 30B0”. The character codes “E002 30A2 30CA 30ED 30B0” stand for the “special code indicating that four characters are to be rendered in a pseudo-combined-character” C21, the character “a” C22, the character “na” C23, the character “ro” C24, and the character “gu” C25. Note that the character codes “E002 30A2 30CA 30ED 30B0” are exchangeable for “0xE0 0x02 0x30 0xA2 0x30 0xCA 0x30 0xED 0x30 0xB0”.

The first pseudo-combined-character rendering module 204 obtains the character codes created by the first pseudo-combined-character determining module 203. The first pseudo-combined-character rendering module 204 detects a special code (Step S206, YES). Then, the first pseudo-combined-character rendering module 204 renders (rasterizes, i.e., creates bitmap data of) a pseudo-combined-character of multiple characters specified by the multiple character codes onto which the special code is added. The first pseudo-combined-character rendering module 204 displays the pseudo-combined-character on the display device 27 (i.e., on word processor software screen). The first pseudo-combined-character rendering module 204 renders the pseudo-combined-character based on outline data of characters specified by the character codes and based on font hinting information included in font data. A method of rendering a pseudo-combined-character by the first pseudo-combined-character rendering module 204 will be described below specifically.

The first pseudo-combined-character rendering module 204 determines whether or not the special code is a special code indicating that two characters are to be rendered in a pseudo-combined-character (Step S207).

Where the special code indicates that two characters are to be rendered in a pseudo-combined-character (Step S207, YES), the first pseudo-combined-character rendering module 204 renders the two characters specified by the two character codes immediately after the special code with the half character width and with the half kerning width (Step S208).

In the example of FIG. 8, the first pseudo-combined-character rendering module 204 renders the two characters “zen” and “ki” specified by the two character codes “524D” and “8A18” immediately after the special code C11 “E000” indicating that two characters are to be rendered in a pseudo-combined-character with the half character width and with the half kerning width. As a result, the first pseudo-combined-character rendering module 204 renders the pseudo-combined-character P10.

Meanwhile, where the special code indicates that three or more characters are to be rendered in a pseudo-combined-character (Step S207, NO), the first pseudo-combined-character rendering module 204 renders the three or more characters specified by the three or more character codes immediately after the special code in two tiers. Specifically, the first pseudo-combined-character rendering module 204 renders the three or more characters with the half character width, with the half character height, and with the half kerning width, by arranging the former half characters/character in the upper tier and the latter half characters/character in the lower tier sequentially and readably (Step S209). The term “sequentially and readably” means that characters are arranged in the linguistically allowable order (for example, in Japanese language, in the order of upper-left, upper-right, lower-left, and lower-right).

In the example of FIG. 9, the first pseudo-combined-character rendering module 204 renders the four characters “a”, “na”, “ro”, and “gu” specified by the four character codes “30A2”, “30CA”, “30ED”, and “30B0” immediately after the special code C21 “E002” indicating that four characters are to be rendered in a pseudo-combined-character with the half character width, with the half character height, and with the half kerning width, by arranging the character “a” upper-left, the character “na” upper-right, the character “ro” lower-left, and the character “gu” lower-right. As a result, the first pseudo-combined-character rendering module 204 renders the pseudo-combined-character P20.

Meanwhile, the first pseudo-combined-character rendering module 204 does not detect a special code (Step S206, NO). Then, the first pseudo-combined-character rendering module 204 renders (rasterizes, i.e., creates bitmap data of) the characters/character specified by the character codes/code created by the first pseudo-combined-character determining module 203 in normal characters/character (not pseudo-combined-characters/character). The first pseudo-combined-character rendering module 204 displays the normal characters/character on the display device 27 (i.e., on word processor software screen) (Step S210).

By the way, the first pseudo-combined-character determining module 203 determines that pseudo-combined-characters/character of the words/word converted by the word conversion module 202 are/is uncreatable (Step S203, NO). In this case, the first pseudo-combined-character determining module 203 displays, as options, multiple normal characters (not pseudo-combined-characters/character) of each of the words/word on the display device 27. The user selects one option (multiple normal characters) via the operation device 26 (input device). The first pseudo-combined-character determining module 203 detects the one option (multiple normal characters) selected via the operation device 26. The first pseudo-combined-character determining module 203 creates the character codes/code standing for the characters/character included in the selected word, and supplies the character codes/code to the first pseudo-combined-character rendering module 204 (Step S211). The first pseudo-combined-character rendering module 204 renders (rasterizes, i.e., creates bitmap data of) the characters/character specified by the character codes/code created by the first pseudo-combined-character determining module 203 in normal characters/character (not pseudo-combined-characters/character). The first pseudo-combined-character rendering module 204 displays the normal characters/character on the display device 27 (i.e., on word processor software screen) (Step S212).

The host apparatus 20 creates a document (including multiple character codes onto which special code is added) by using the word processor software 210 according to the aforementioned method. The host apparatus 20 creates printable data (including multiple character codes onto which special code is added) of the document by using the printer driver 220. The host apparatus 20 sends the printable data to the image forming apparatus 10 via the network communication interface 25 (communication device).

7. Operational Flow of Image Forming Apparatus

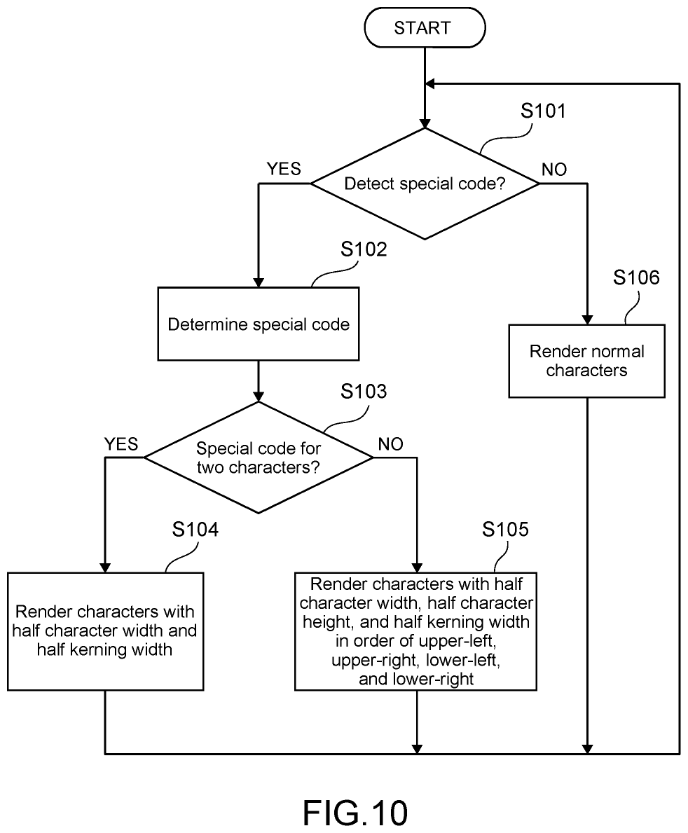

FIG. 10 shows an operational flow of the image forming apparatus.

The image forming apparatus 10 receives printable data from the host apparatus 20 via the network communication interface 13 (communication device). The character rendering module 101 obtains text information (i.e., multiple character codes standing for multiple characters) of the printable data.

The second pseudo-combined-character determining module 102 detects a special code in the printable data (Step S101, YES). Then, the second pseudo-combined-character determining module 102 determines whether or not the special code is a special code indicating that two characters are to be rendered in a pseudo-combined-character (Step S102).

The second pseudo-combined-character rendering module 103 renders (rasterizes, i.e., creates bitmap data of) a pseudo-combined-character of multiple characters specified by the multiple character codes onto which the special code is added. The second pseudo-combined-character rendering module 103 renders the pseudo-combined-character based on outline data of characters specified by the character codes and based on font hinting information included in font data. A method of rendering a pseudo-combined-character by the second pseudo-combined-character rendering module 103 will be described below specifically.

Where the special code indicates that two characters are to be rendered in a pseudo-combined-character (Step S103, YES), the second pseudo-combined-character rendering module 103 renders the two characters specified by the two character codes immediately after the special code with the half character width and with the half kerning width (Step S104).

In the example of FIG. 8, the second pseudo-combined-character rendering module 103 renders the two characters “zen” and “ki” specified by the two character codes “524D” and “8A18” immediately after the special code C11 “E000” indicating that two characters are to be rendered in a pseudo-combined-character with the half character width and with the half kerning width. As a result, the second pseudo-combined-character rendering module 103 renders the pseudo-combined-character P10. As a result, the pseudo-combined-character P11 is to be printed on a medium.

Meanwhile, where the special code indicates that three or more characters are to be rendered in a pseudo-combined-character (Step S103, NO), the second pseudo-combined-character rendering module 103 renders the three or more characters specified by the three or more character codes immediately after the special code in two tiers. Specifically, the second pseudo-combined-character rendering module 103 renders the three or more characters with the half character width, with the half character height, and with the half kerning width, by arranging the former half characters/character in the upper tier and the latter half characters/character in the lower tier sequentially and readably (Step S105). The term “sequentially and readably” means that characters are arranged in the linguistically allowable order (for example, in Japanese language, in the order of upper-left, upper-right, lower-left, and lower-right).

In the example of FIG. 9, the second pseudo-combined-character rendering module 103 renders the four characters “a”, “na”, “ro”, and “gu” specified by the four character codes “30A2”, “30CA”, “30ED”, and “30B0” immediately after the special code C21 “E002” indicating that four characters are to be rendered in a pseudo-combined-character with the half character width, with the half character height, and with the half kerning width, by arranging the character “a” upper-left, the character “na” upper-right, the character “ro” lower-left, and the character “gu” lower-right. As a result, the second pseudo-combined-character rendering module 103 renders the pseudo-combined-character P20. As a result, the pseudo-combined-character P21 is to be printed on a medium.

Meanwhile, where no special code is added onto the character codes/code (Step S101, NO), the second pseudo-combined-character rendering module 103 renders (rasterizes, i.e., creates bitmap data of) the characters/character specified by the character codes/code in normal characters/character (not pseudo-combined-characters/character) (Step S106).

8. Conclusion

A set of character codes such as JIS or Unicode has character codes for rendering combined-characters. The “combined-character” is a character including multiple characters in a single character area, and is used to have more information in a limited space. According to the “character code for rendering a combined-character”, one character stands for a “combined-character” i.e., a “character including multiple characters in a single character area”. For example, in Unicode for Japanese language, one character code “Unicode U+330D JIS 13-42” stands for a “character including multiple characters “calorie” (in Japanese language) in a single character area”. In the combined-character “calorie” in Japanese language, the multiple characters “calorie” (in Japanese language) are arranged, in a single character area, from the upper tier to the lower tier sequentially and readably. As described above, a set of character codes includes character codes standing for such combined-characters. However, combined-characters included in a set of character codes are not all the words including multiple characters. As a result, where a set of character codes does not include a character code standing for a combined-character of a certain word, it is impossible to render a combined-character of such a word.

(1) To the contrary, according to the present embodiment, the host apparatus 20 is configured to create a pseudo-combined-character of a word, where a character code standing for a combined-character of the word is not included in a set of character codes. Specifically, the host apparatus 20 adds a special code onto a certain position of (for example, immediately before) the multiple character codes standing for the multiple characters included in the selected word, the special code indicating that the multiple characters are to be rendered in the pseudo-combined-character. In this way, the host apparatus 20 is capable of rendering a pseudo-combined-character of a word, where a character code standing for a combined-character of the word is not included in a set of character codes, easily and reliably. In other words, the host apparatus 20 is capable of rendering pseudo-combined-characters without additionally including character codes standing for combined-characters themselves in the set of character codes.

(2) According to the present embodiment, the host apparatus 20 may be configured to determine that the pseudo-combined-character is creatable where the word is registered in the pseudo-combined-character conversion list 212. According to the present configuration, the host apparatus 20 may render pseudo-combined-characters of appropriate words, or may differentiate words to be rendered in pseudo-combined-characters depending on needs of each user.

(3) According to the present embodiment, the pseudo-combined-character conversion list 212 may register, as the multiple words each including the multiple characters, multiple words having high use frequencies, multiple words having antonyms, and/or multiple words having synonyms. According to the present configuration, the host apparatus 20 may determine words, whose pseudo-combined-characters are creatable, more appropriately.

(4) According to the present embodiment, the host apparatus 20 may be configured to determine whether or not a pseudo-combined-character of the word is creatable, where the pseudo-combined-character is creatable, display the pseudo-combined-character of the word and normal characters of the word as options on the display device 27, the normal characters being not a pseudo-combined-character, and where the pseudo-combined-character is selected via the operation device 26, determine that the pseudo-combined-character of the word is to be rendered. According to the present configuration, a user may visually compare a pseudo-combined-character and a normal character, and select the one optimum option (pseudo-combined-character or normal character).

(5) According to the present embodiment, the host apparatus 20 may be configured to display multiple pseudo-combined-characters of the multiple words, respectively, and multiple normal characters of the multiple words, respectively, as options on the display device 27, the multiple normal characters being not pseudo-combined-characters, and where one of the pseudo-combined-characters is selected via the operation device 26, determine that the selected pseudo-combined-character is to be rendered. According to the present configuration, a user may visually compare a pseudo-combined-character and a normal character, and select the one optimum option (pseudo-combined-character or normal character).

(6) According to the present embodiment, the host apparatus 20 may be configured to limit a total number of the multiple pseudo-combined-characters and the multiple normal characters displayed on the display device 27. According to the present configuration, since the total number is limited as a fixed value, a user may not feel uncomfortable different from a case where a large number of options are displayed.

(7) According to the present embodiment, the host apparatus 20 may display multiple pseudo-combined-characters of a certain number of multiple words, respectively, and may not display multiple pseudo-combined-characters of rest multiple words, respectively. According to the present configuration, a user may not feel uncomfortable different from a case where a large number of options are displayed.

(8) According to the present embodiment, the host apparatus 20 is configured to create printable data including the multiple character codes onto which the special code is added, and send the printable data to the image forming apparatus 10. According to the present configuration, the image forming apparatus 10 is capable of rendering and printing pseudo-combined-characters by interpreting the special codes.

(9) According to the present embodiment, the special code may be assigned to a private use area of a set of character codes. Since a private use area of a set of character codes is used, it is possible to create special codes highly flexibly. Further, according to the present configuration, the host apparatus 20 is capable of rendering pseudo-combined-characters without additionally including character codes standing for combined-characters themselves in the set of character codes.

(10) According to the present embodiment, the pseudo-combined-character is a character including multiple characters in a single character area. According to the present configuration, even if a set of character codes does not include a character code standing for a combined-character of a certain word, it is possible to create a pseudo-combined-character of such a word such that it is difficult to distinguish between the pseudo-combined-character and a combined-character. Even if a set of character codes does not include a character code standing for a combined-character of a certain word, it is possible to have more information in a limited space by using a pseudo-combined-character.

(11) According to the present embodiment, the host apparatus 20 may be configured to render the pseudo-combined-character based on outline data of characters specified based on the character codes. According to the present configuration, it is possible to render pseudo-combined-characters of any possible characters, and it is possible to render pseudo-combined-characters with any possible layouts.

(12) According to the present embodiment, the special code is different depending on a number of multiple characters to be rendered in a pseudo-combined-character. In other words, a special code indicating that two characters are to be rendered in a pseudo-combined-character is different from a special code indicating that four characters are to be rendered in a pseudo-combined-character. In other words, it is only necessary to create special codes, the number of the special codes being the same as the number of multiple characters to be rendered in pseudo-combined-characters. For example, where two to ten characters are to be rendered as pseudo-combined-characters, it is only necessary to create nine special codes. According to the present configuration, it is only necessary to assign nine special codes to a private use area of a set of character codes, which occupies very small capacities of the private use area. Only by creating such a small number of (i.e., nine) special codes, it is possible to render any possible words in pseudo-combined-characters.

It should be understood by those skilled in the art that various modifications, combinations, sub-combinations and alterations may occur depending on design requirements and other factors insofar as they are within the scope of the appended claims or the equivalents thereof

What is claimed is:

1. A host apparatus, comprising:
a display device; and
a controller circuit configured to operate as
a character input module in which multiple characters are input,
a word conversion module configured to convert the multiple characters into a word,
a first pseudo-combined-character determining module configured to
determine whether or not a pseudo-combined-character of the word is creatable,
where the pseudo-combined-character is creatable, determine whether or not the pseudo-combined-character of the word is to be rendered, and
where the pseudo-combined-character is to be rendered, add a special code onto a certain position of multiple character codes, the multiple character codes standing for the multiple characters included in the word, the special code indicating that the multiple characters are to be rendered in the pseudo-combined-character, and
a first pseudo-combined-character rendering module configured to render the multiple characters in the pseudo-combined-character and display the pseudo-combined-character on the display device, the multiple characters being specified by the multiple character codes onto which the special code is added.

2. The host apparatus according to claim 1, further comprising:
a storage device configured to store a pseudo-combined-character conversion list, multiple words being registered in the pseudo-combined-character conversion list, each of the multiple words including multiple characters, wherein
the first pseudo-combined-character determining module is configured to determine that the pseudo-combined-character is creatable where the word is registered in the pseudo-combined-character conversion list.

3. The host apparatus according to claim 2, wherein
the pseudo-combined-character conversion list registers, as the multiple words each including the multiple characters, multiple words having high use frequencies, multiple words having antonyms, and/or multiple words having synonyms.

4. The host apparatus according to claim 1, further comprising:
an input device configured to receive input by a user, wherein
the first pseudo-combined-character determining module is configured to
determine whether or not a pseudo-combined-character of the word is creatable,
where the pseudo-combined-character is creatable, display the pseudo-combined-character of the word and normal characters of the word as options on the display device, the normal characters being not a pseudo-combined-character, and
where the pseudo-combined-character is selected via the input device, determine that the pseudo-combined-character of the word is to be rendered.

5. The host apparatus according to claim 4, wherein
the word conversion module is configured to convert the multiple characters into multiple words, and
the first pseudo-combined-character determining module is configured to
determine whether or not pseudo-combined-characters of the multiple words, respectively, are creatable,
where the pseudo-combined-characters of the multiple words are creatable, respectively, display multiple pseudo-combined-characters of the multiple words, respectively, and multiple normal characters of the multiple words, respectively, as options on the display device, the multiple normal characters being not pseudo-combined-characters, and
where one of the pseudo-combined-characters is selected via the input device, determine that the selected pseudo-combined-character is to be rendered.

6. The host apparatus according to claim 5, wherein
the first pseudo-combined-character determining module is configured to limit a total number of the multiple pseudo-combined-characters and the multiple normal characters displayed on the display device.

7. The host apparatus according to claim 6, wherein
the first pseudo-combined-character determining module is configured to
to display multiple pseudo-combined-characters of a certain number of multiple words, respectively, and
not to display multiple pseudo-combined-characters of rest multiple words, respectively.

8. The host apparatus according to claim 1, further comprising:
a communication device, wherein
the controller circuit is further configured to operate as
a printer driver configured to
create printable data including the multiple character codes onto which the special code is added, and
send the printable data to an image forming apparatus via the communication device.

9. The host apparatus according to claim 1, wherein
the special code is assigned to a private use area of a set of character codes.

10. The host apparatus according to claim 1, wherein
the pseudo-combined-character is a character including multiple characters in a single character area.

11. The host apparatus according to claim 10, wherein
the first pseudo-combined-character rendering module is configured to render the pseudo-combined-character based on outline data of characters specified based on the character codes.

12. The host apparatus according to claim 1, wherein
the special code is different depending on a number of multiple characters to be rendered in a pseudo-combined-character.

13. An image forming apparatus, comprising:
a communication device;
a printer device; and
a controller circuit configured to operate as
a second pseudo-combined-character determining module configured to detect multiple character codes and a special code from printable data received from a host apparatus via the communication device, the multiple character codes standing for multiple characters, the special code being added onto a certain position of the multiple character codes, the special code indicating that the multiple characters are to be rendered in a pseudo-combined-character, and
a second pseudo-combined-character rendering module configured to render the multiple characters in the pseudo-combined-character such that the printer device prints the pseudo-combined-character, the multiple characters being specified by the multiple character codes onto which the special code is added.

14. The image forming apparatus according to claim 13, wherein
the pseudo-combined-character is a character including multiple characters in a single character area.

15. The image forming apparatus according to claim 14, wherein
the second pseudo-combined-character rendering module is configured to render the pseudo-combined-character based on outline data of characters specified based on the character codes.

16. A non-transitory computer readable recording medium that stores a pseudo-combined-character rendering program executable by a host apparatus including a display device and a controller circuit, the pseudo-combined-character rendering program causing the controller circuit of the host apparatus to operate as
a character input module in which multiple characters are input,
a word conversion module configured to convert the multiple characters into a word,
a first pseudo-combined-character determining module configured to
determine whether or not a pseudo-combined-character of the word is creatable,
where the pseudo-combined-character is creatable, determine whether or not the pseudo-combined-character of the word is to be rendered, and
where the pseudo-combined-character is to be rendered, add a special code onto a certain position of multiple character codes, the multiple character codes standing for the multiple characters included in the word, the special code indicating that the multiple characters are to be rendered in the pseudo-combined-character, and
a first pseudo-combined-character rendering module configured to render the multiple characters in the pseudo-combined-character and display the pseudo-combined-character on the display device, the multiple characters being specified by the multiple character codes onto which the special code is added.

17. The non-transitory computer readable recording medium according to claim 16, wherein
the host apparatus further includes a storage device configured to store a pseudo-combined-character conversion list, multiple words being registered in the pseudo-combined-character conversion list, each of the multiple words including multiple characters, and
the first pseudo-combined-character determining module is configured to determine that the pseudo-combined-character is creatable where the word is registered in the pseudo-combined-character conversion list.

18. The non-transitory computer readable recording medium according to claim 17, wherein
the pseudo-combined-character conversion list registers, as the multiple words each including the multiple characters, multiple words having high use frequencies, multiple words having antonyms, and/or multiple words having synonyms.

19. The non-transitory computer readable recording medium according to claim 16, wherein
the host apparatus further includes an input device configured to receive input by a user, and
the first pseudo-combined-character determining module is configured to
determine whether or not a pseudo-combined-character of the word is creatable,
where the pseudo-combined-character is creatable, display the pseudo-combined-character of the word and normal characters of the word as options on the display device, the normal characters being not a pseudo-combined-character, and
where the pseudo-combined-character is selected via the input device, determine that the pseudo-combined-character of the word is to be rendered.

20. The non-transitory computer readable recording medium according to claim 19, wherein
the word conversion module is configured to convert the multiple characters into multiple words, and
the first pseudo-combined-character determining module is configured to
determine whether or not pseudo-combined-characters of the multiple words, respectively, are creatable,
where the pseudo-combined-characters of the multiple words are creatable, respectively, display multiple pseudo-combined-characters of the multiple words, respectively, and multiple normal characters of the multiple words, respectively, as options on the display device, the multiple normal characters being not pseudo-combined-characters, and
where one of the pseudo-combined-characters is selected via the input device, determine that the selected pseudo-combined-character is to be rendered.
